(19) United States
(12) Patent Application Publication
(10) Pub. No.: US 2025/0206161 A1
(43) Pub. Date: Jun. 26, 2025

(54) CHARGE RAIL AND SYSTEM FOR CHARGING A PARKED ROAD VEHICLE

(71) Applicant: Elonroad AB, Lund (SE)

(72) Inventor: Dan ZETHRAEUS, Lund (SE)

(21) Appl. No.: 18/851,993

(22) PCT Filed: Mar. 24, 2023
(86) PCT No.: PCT/EP2023/057660

§ 371 Date: Sep. 27, 2024

(30) Foreign Application Priority Data
Mar. 30, 2022 (SE) 2250396-5

(51) Int. Cl. B60L 53/16; B60L 53/10

(52) U.S. Cl. CPC B60L 53/16; B60L 53/11

(57) ABSTRACT

A charge rail for charging a parked road vehicle is provided. The charge rail comprising: a charging control segment; a first charging segment; a second charging segment; and a Protective Earth, PE, segment. The segments are arranged one after another along a longitudinal extension of the charge rail, are electrically conducting, and are mutually electrically isolated from each other. The charge rail further comprising a base supporting the segments.

### TECHNICAL FIELD

The present disclosure belongs to a charge rail and a system for charging a parked road vehicle.

### BACKGROUND

The number of electrically powered vehicles presently increases in a never-before-seen rate, as traditional combustion engines are being replaced or combined with electric motors for reducing the dependence on fossil fuels for transportation. This applies also for heavy road vehicles such as trucks or other work vehicles as batteries are becoming increasingly powerful as well as increasingly efficient from a charging point of view.

Charging of a parked road vehicle is commonly done by a cable connected between the charging station and the parked road vehicle. Hence, a person, e.g., the driver of the road vehicle, needs to manually attach the cable to the exterior of the road vehicle. Furthermore, for safety reasons, common modern standards locks the cable socket of the cable to the parked road vehicle while charging. This may reduce conveniency in terms of flexibility on, e.g., a cargo platform should a heavy road vehicle need to be moved at short notice, or the like.

Hence, there is a need for a more flexible approach for charging a parked road vehicle.

### SUMMARY

An object of the invention is to provide an approach for a more flexible charging of a parked road vehicle.

According to a first aspect a charge rail for charging a parked road vehicle is provided. The charge rail comprises:
a charging control segment;
a first charging segment;
a second charging segment;
a Protective Earth, PE, segment;
wherein the segments are arranged one after another along a longitudinal extension of the charge rail, are electrically conducting, and are mutually electrically isolated from each other.

The parked road vehicle is hereinto be viewed as a road vehicle capable of driving on roads, where the road vehicle is temporarily stationary. For example, the road vehicle may be a truck, a car, a bus, a forklift, an excavator, a dumper truck, a tractor, a mining equipment, etc.

A parked road vehicle may be easily reallocated since a driver of the road vehicle may not need to leave a cockpit of the road vehicle while connecting or disconnecting to the charge rail. Hence, a more flexible charging of a parked road vehicle may be provided for. Further, the charge rail may be arranged on a cargo platform such that charging may be done during loading and/or unloading of the road vehicle. Hence, time may be saved since charging and loading/unloading can be done simultaneously.

The charge rail may comprise a base supporting the segments.

The charge rail may comprise a Combined Charging System, CCS, arrangement. The CCS arrangement may be supported by the base. The CCS arrangement may be a CCS coupler. The CCS arrangement comprises a control pilot, CP, connector, a negative direct current, DC−, connector, a positive direct current, DC+, connector, and a protective Earth, PE, connector. In contrast to an ordinary CCS charger, a proximity pilot, PP, connector may be redundant for the present CCS arrangement. This since a PP connector for an ordinary CCS socket is arranged to lock the CCS socket to the vehicle while charging.

The PE connector may be connected to the PE segment.

The DC− connector may be connected to the first charging segment. Hence, the first charging segment may be referred to as a DC− segment.

The DC+ connector may be connected to the second charging segment. Hence, the second charging segment may be referred to as a DC+ segment.

The CP connector may be connected to the charging control segment. Hence, the charging control segment may be referred to as a CP segment. The term control pilot, CP, has its ordinary meaning within CCS chargers. Hence, control pilot is a communication line used to signal charging level. Moreover, breaking of the CP communication line will stop charging of the battery of the road vehicle. That is, if the CP communication line is broken, no power will be delivered to the DC− segment and the DC+ segment. DC−, DC+, and PE have their ordinary meaning within CCS chargers too.

The segments may be spatially ordered in any suitable ordering along the longitudinal extension. Hence, there are 24 different permutations for ordering these four segments.

The segments may have a same longitudinal extension, preferably in a range of 500-900 mm. This facilitates a parking tolerance for the road vehicle upon connecting to the charge rail. Preferably the longitudinal extension of a respective segment is approximately 700 mm.

The first and second charging segments may be arranged between the charging control and PE segments. Hence, along the longitudinal extension, the charging control and PE segments may be located at longitudinal ends, whereas the first and second charging segments are located therebetween. This facilitate protecting high-voltage parts of the charge rail. Hence, safety may be facilitated. This since the charging control and PE segments are less harmful in the event of short circuit.

The charge rail may further comprise a switch configured to switch a polarity of the first and second charging segments (e.g. in the form of DC− and DC+ segments). This allows for parking of the road vehicle along the longitudinal extension of the charge rail in either of the two possible directions. Should the parking direction of the road vehicle be opposite, this opposite parking direction may be detected by antenna receivers. Switching may thus be facilitated using a relay in the road vehicle or at the charge rail such that charging control- and PE signals are correctly ordered. The ordering of the first and second charging (e.g. in the form of DC− and DC+) may further be switched via diodes, and may thereby not necessarily be switched by a relay. This may further facilitate convenience and save time.

An underside of the base may comprise an insulating layer. This allow for preventing short circuit situations that may occur via saltwater being present at the charge rail. Hence, safety may be facilitated.

According to a second aspect, there is provided a stationary charger arrangement comprising:
a charge rail according to the first aspect; and
a safety arrangement configured to stop a charging of the parked road vehicle upon a foreign object approaching the charge rail.

The above-mentioned features and advantages of the charge rail apply to this second aspect as well. To avoid undue repetition, reference is made to the above when applicable. The safety arrangement may thereby break a current used for charging the parked road vehicle. The foreign object may include human interaction, an animal approaching the charge rail, or the like. Hence, the safety arrangement facilitate safety, preventing fire or chemical leakage from a battery, or the like.

The safety arrangement may comprise a curtain protection arranged along the charge rail. The curtain protection is extendible between the parked road vehicle and a surface on which the charge rail is arranged.

The curtain protection may be extendible from an underside of the parked road vehicle. Alternatively, the curtain protection may be extendible from the charge rail. The curtain protection may be manufactured in any suitable material. This may facilitate a safe and simple safety system for preventing accidents associated with high voltage currents.

The curtain protection comprises one or more breakers configured to stop a charging of the parked road vehicle upon the curtain protection being tampered with. Charging may thereby be stopped whenever the curtain protection is touched, lifted, or the like. The brakers may be arranged to break a charging control communication line, e.g. a CP communication line. This since a breaking of the charging control communication line (e.g. the CP communication line) typically implies stop charging, i.e., stopping power current for charging the battery of the road vehicle. Hence, safety may be facilitated.

The safety arrangement may comprise one or more of a radar, a camera, a temperature sensor, and a passive infrared, PIR, sensor. This may further facilitate safety.

According to a third aspect, there is provided a system for charging a parked road vehicle, the system comprising:
a charge rail according to the first aspect,
a charge pickup arrangement connected to a chassis of a road vehicle, the charge pickup arrangement having a set of connecting elements comprising:
   a charging control connecting element;
   a first charging connecting element;
   a second charging connecting element; and
   a Protective Earth, PE, connecting element.

The charging control connecting element may be a control pilot, CP, connecting element. The first charging connecting element may be a negative direct current, DC−, connecting element. The second charging connecting element may be a positive direct current, DC+, connecting element.

The above-mentioned features and advantages of the charge rail apply to this second aspect as well. To avoid undue repetition, reference is made to the above when applicable. The charge pickup arrangement may be retrofitted on an underside of the road vehicle. Hence, an ordinary at least partially electrically powered road vehicle may be converted such that charging of its battery may be possible using the charge rail. Alternatively, the road vehicle may be equipped with the charge pickup arrangement at manufacturing of the same.

The system may further comprise a safety arrangement configured to stop a charging of the parked road vehicle upon a foreign object approaching the charge rail.

A proximal end of each connecting element of the set of connecting elements may be vertically movable to form an electrical contact to a matching segment of the charge rail, thereby allowing charging of the road vehicle. Hence, while charging the road vehicle, the charging control connecting element is connected to the charging control segment, the first charging connecting element is connected to the first charging segment, the second charging connecting element is connected to the second charging segment, and the PE connecting element is connected to the PE segment.

The proximal end of respective connecting element of the set of connecting elements may have a transverse extension transverse to the longitudinal extension of the charge rail (provided the road vehicle is correctly parked on the charge rail). The transverse extension may be in the range of 0.1-2 m, and more preferably in the range of 0.3-0.6 m. This may provide a sufficient tolerance for parking, i.e., simplifying parking of the road vehicle such that charging via the charge rail is possible. Additionally, or alternatively, the proximal end of each connecting element may be movable along the transverse extension such that electrical connection between the connecting elements and the charge rail is established even if the road vehicle is obliquely parked relative to the charge rail, hence facilitating a substantial parking tolerance.

Each connecting element of the set of connecting elements may be pivotably attached to the chassis of the road vehicle. This may reduce space for the charge pickup arrangement while not in use.

Each connecting element of the set of connecting elements may comprise a biasing member configured to provide an additional pressure between each connecting member and a matching segment while charging the road vehicle. The biasing member may be a spring, an elastic material, hydraulic or pneumatic means, or the like. This may prevent losing electrical contact during charging and thereby facilitate improved charging reliability.

A further scope of applicability of the present invention will become apparent from the detailed description given below. However, it should be understood that the detailed description and specific examples, while indicating preferred embodiments of the invention, are given by way of illustration only, since various changes and modifications within the scope of the invention will become apparent to those skilled in the art from this detailed description.

Hence, it is to be understood that this invention is not limited to the particular component parts of the device described or acts of the methods described as such device and method may vary. It is also to be understood that the terminology used herein is for purpose of describing particular embodiments only and is not intended to be limiting. It must be noted that, as used in the specification and the appended claim, the articles “a,” “an,” “the,” and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The above, as well as additional objects, features, and advantages of the present invention, will be better understood through the following illustrative and non-limiting detailed description of preferred embodiments, with reference to the appended drawings, where the same reference numerals will be used for similar elements, wherein:

FIG. 1A shows, highly schematically, a perspective view of a charge rail for charging a parked road vehicle.

FIGS. 1B-1E show, highly schematically, several cross-sectional profiles of an insulating layer located beneath a charge rail.

FIG. 1F shows, highly schematically, a top view of a charge rail for charging a parked road vehicle.

FIG. 2 schematically shows a stationary charge arrangement.

FIG. 3 shows a system for charging a parked road vehicle.

FIGS. 4A-4B show a perspective view of a charge pickup arrangement for charging a parked road vehicle.

FIGS. 5A-5B show a side view of a charge pickup arrangement for charging a parked road vehicle.

FIG. 6A shows, highly schematically, a charge pickup arrangement of a first type being placed in parallel with a charge rail.

FIG. 6B shows, highly schematically, a charge pickup arrangement of a first type being non-parallel placed with a charge rail.

FIG. 6C shows, highly schematically, a charge pickup arrangement of a second type being placed in parallel with a charge rail.

FIG. 6D shows, highly schematically, a charge pickup arrangement of a second type being non-parallel placed with a charge rail.

FIG. 6E shows, highly schematically, a charge pickup arrangement of a second type being laterally adjusted relative a charge rail.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and to fully convey the scope of the invention to the skilled person.

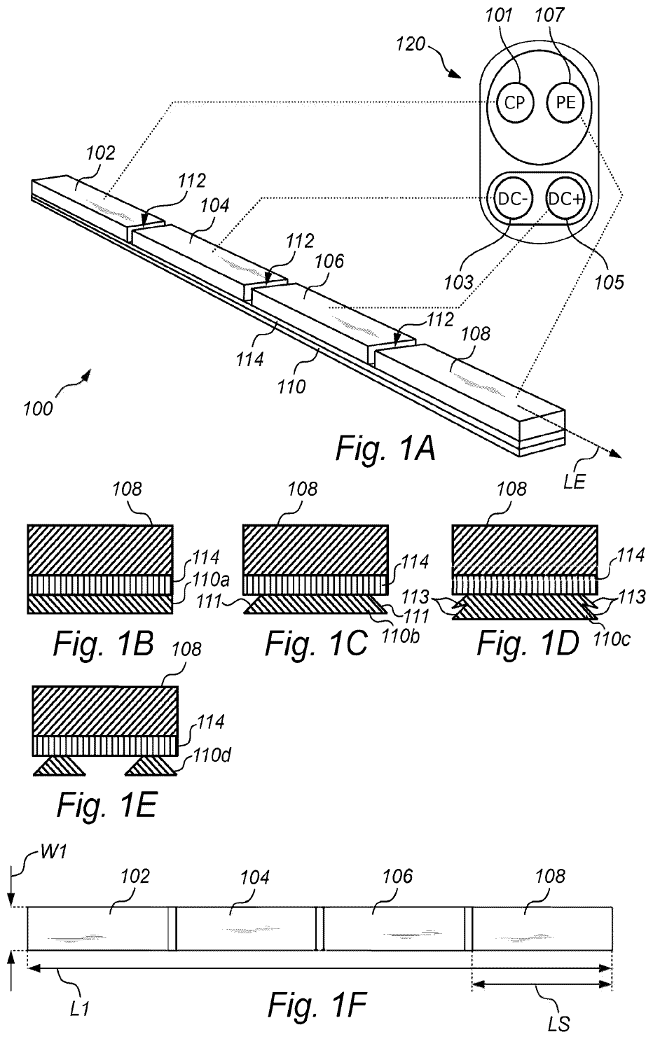

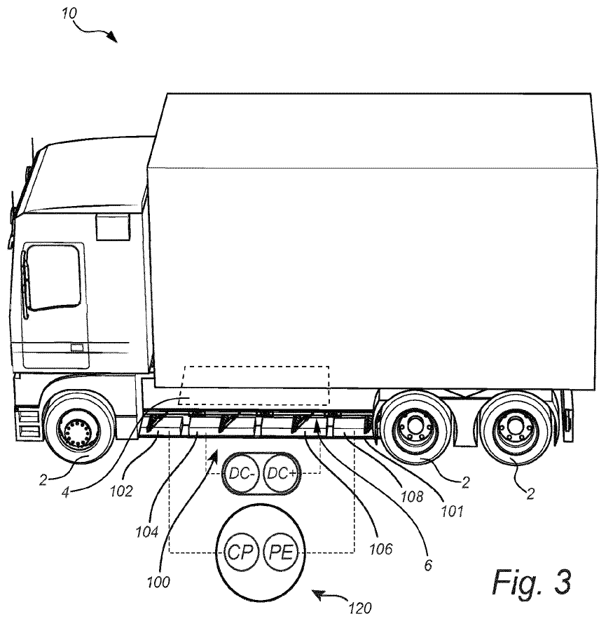

In connection with FIG. 1A there is shown a charge rail 100 for charging a parked road vehicle 10. The road vehicle 10 may be a road vehicle suitable for driving on an ordinary road. Non-limiting examples are a car, a bus, and a truck 10, a forklift, an excavator, a dumper truck, a tractor, and a mining equipment. An example road vehicle 10 is shown in FIG. 3. The road vehicle 10 may have electrically insulating tires/wheels 2, e.g., made of rubber, suitable for driving on any adequate type of road surfaces, such as asphalt, concrete, gravel, or forest roads. Hence, a “parked road vehicle 10” refers to a road vehicle 10 being temporarily stationary.

The charge rail 100 comprises a charging control segment 102, a first charging segment 104, a second charging segment 106, and a Protective Earth, PE, segment. The segments 102, 104, 106, 108 are arranged one after another along a longitudinal extension LE of the charge rail 100. The segments 102, 104, 106, 108 are mutually electrically isolated from each other. The segments 102, 104, 106, 108 are electrically conducting. The segments 102, 104, 106, 108 may be made of any suitable electrically conducting material/compound, e.g., copper, steel, or the like. It is appreciated that different segments 102, 104, 106, 108 may be made of different materials/compounds, e.g., the control segment 102 may be made of copper, and the first charging segment 104 may be made of steel, etc. The segments 102, 104, 106, 108 may be mutually electrically isolated from each other by any suitable insulating means 112. Insulating means may for instance be air, plastic or rubber. Electrical provision to a battery 4 of the parked road vehicle 10 may be made by a 0-200 A direct current. Alternatively, alternating current may be used. A preferable voltage range of the charging is 200-1000 V, the electrical effect during charging may be 0-200 kW. Charging of the road vehicle may be activated by wireless means such as Wi-Fi, Bluetooth, 3G, 4G, 5G, or the like.

The charge rail 100 may, as in the in FIG. 1 illustrated example, comprise a combined charging system, CCS, arrangement 120, preferably in the form of a CCS coupler. If so the charge rail 100 can easily be connected to a CCS compatible charger. However, it is to be understood that the charge rail 100 may be connected to other types of chargers for charging a vehicle, such as a Megawatt Charging System, MCS, compatible charger, a CHAdeMO compatible charger, a Type 2 compatible charger or any future charging system. Moreover, the charge rail 100 may be a part of a custom charging system. The CCS arrangement 120 comprises a control pilot, CP, connector 101, a negative direct current, DC−, connector 103, a positive direct current, DC+, connector 105, and a protective Earth, PE, connector 107. The CP connector 101 is connected to the charging control segment 102. Hence, the charging control segment 102 may be referred to as a control pilot, CP, segment. The DC− connector 103 is connected to the first charging segment 104. Hence, the first charging segment 104 may be referred to as a DC− segment. The DC+ connector 105 is connected to the second charging segment 106. Hence, the second charging segment 106 may be referred to as a DC− segment. The PE connector is connected to the PE segment. A schematic CCS combo connector is shown to illustrate the counterparts of the CCS combo connector with the segments 102, 104, 106, 108 of the charge rail 100. As set out above in the summary section, a PP socket, normally included in a CCS combo connector, may be redundant for the charge rail 100.

The charge rail 100 further comprises a base 114 supporting the segments 102, 104, 106, 108. The base may also support the CCS arrangement or any other type of connecting arrangement for connecting the charge rail 100 to a charger.

The segments 102, 104, 106, 108 may have a same longitudinal extension. This longitudinal extension of a segment may be denoted the length LS of the segment. Preferably, the length LS of each segment is in a range of 500-900 mm. More preferably, the length of each segment is approximately 700 mm. A width W1 of each segment, i.e., a transverse extension being transverse to the longitudinal extension LE, may be substantially smaller than the length of the segment. A non-limiting example is that the width is 50-200 mm. The segments 102, 104, 106, 108 may all be mutually structurally similar in terms of dimensions and material. However, mutual differences among the segments 102, 104, 106, 108 may occur within the claimed scope.

The first and second charging segments 104, 106 may be arranged between the charging control segment 102 and the PE segment 108. Hence, charging control segment 102 and the PE segment 108 may be a first and a last segment along the longitudinal extension LE of the charge rail 100, and the first and second charging segments 104, 106 may be a second and a third segment along the longitudinal extension LE of the charge rail 100. This ordering may be advantageous from a safety point of view, since the charging control segment 102 and the PE segment 108 are subject to smaller currents/voltages. That is, along the longitudinal extension LE the first and second charging segments 104, 106 are substantially protected by the charging control segment 102 and the PE segment 108. However, other orderings of the segments 102, 104, 106, 108 may be possible within the claimed scope.

The charge rail 100 may further comprise a switch (not shown). The switch may be configured to switch a polarity of the first and second charging segments 104, 106. The switch may be a diode, a relay, or the like. The charge rail 100 may further comprise a second switch configured to switch an electrical function of the charging control segment 102 and the PE segment 108. That is, the segment being associated with charging control connectability may be changed to PE connectability, and vice versa for the conducting segment being associated with PE connectability. Alternatively, the charge rail 100 may comprise a single switch configured to reverse electrical ordering of the segments 102, 104, 106, 108.

An underside of the base 114 may comprise an insulating layer 110. Alternatively, the insulating layer 110 may, partially or entirely, form part of the base 114. Alternatively, the base 114 may be a rail being made of any suitable material. As such, the base 114 may be located vertically below the insulating layer 114. The insulating layer 110 may be made of any electrically/thermally insulating material, such as rubber, plastic, or the like. Additionally, or alternatively, the insulating layer 110 may have a cross-sectional profile configured to prevent liquid forming a substantial electrical contact between the segments and the ground on which the base layer is located, thereby preventing, e.g., a short-circuit between the first and second charging segments 104, 106. The liquid in question may be water, saltwater, or any anti-slip substance for use in icy/snowy weather, capable of forming an undesired electrical contact between segments or between other nearby objects. At a conceptual level, the cross-sectional profile may be such that the liquid is forced to split up in disconnected portions between a segment and the ground or between segments. Examples of cross-sectional profiles are given in FIGS. 1B-E. In FIG. 1B, a general structure of the charge rail 100 is highly schematically shown, showing the cross-sectional profile of a segment 108, the base layer 114 and the insulating layer 110a. In FIG. 1C, an alternative cross-sectional profile of the insulating layer is shown. Here, the cross-sectional profile has a slanted portion 111 at respective end seen along the transverse extension of the segment 108. This may prevent liquid to flow in a fluidly connected manner along an edge of the charge rail and the insulating layer. In FIG. 1D, yet another alternative of a cross-sectional profile 110c of the insulating layer 110 is shown. Here, a plurality of slanted portions 113 at respective end is present. This may further prevent liquid to flow in a fluidly connected manner along the edge of the charge rail 100 and the insulating layer 110. The insulating layer 110 may, as yet another option, comprise a plurality of insulating portions 110d, as shown in FIG. 1E. The skilled person appreciates the existence of many variants of the insulating layer.

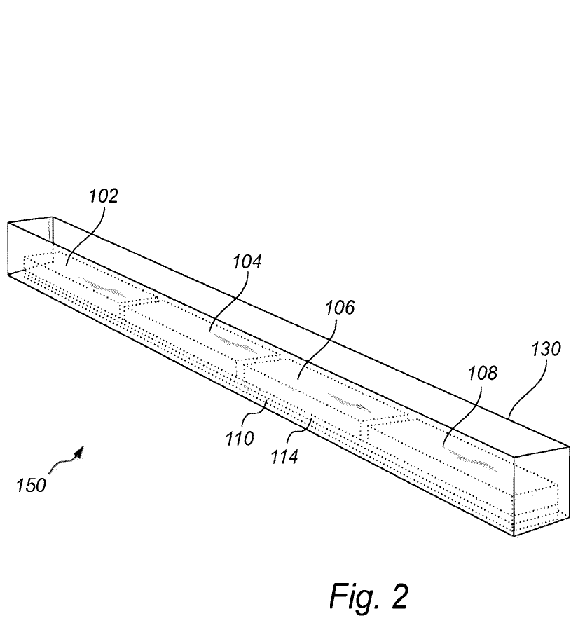

In connection with FIG. 2, there is shown a stationary charger arrangement 150.

The stationary charger arrangement 150 comprises a charge rail 100. The above description of the charge rail 100 apply also here. Hence, to avoid undue repetition, reference is made to the above when applicable.

The stationary charger arrangement 150 further comprises a safety arrangement. The safety arrangement is configured to stop a charging of the parked road vehicle 10 upon a foreign object approaching the charge rail 100. To this end, the safety arrangement may comprise a curtain protection 130 arranged along the charge rail 100. The curtain protection 130 may be extendible between the parked road vehicle 10 and a surface on which the charge rail 100 is arranged. The curtain protection 130 may be made of any suitable material, e.g., an insulating material. The curtain protection 130 may be made of a flexible sheet material, such as synthetic fabric, rubber, plastic, a combination thereof, or the like. Alternatively, the curtain protection 130 may be made of any rigid material such that the curtain protection is able to substantially maintain its shape even if not suspended by suspension means. Examples may be an elongated substantially rigid curtain protection having a cylindrical or rectangular shape seen from above, wherein the curtain protection 130 has a sleeve enclosing the charge rail 100, and wherein the curtain protection 130 has an axial extension extending vertically. Alternatively, the curtain protection 130 may comprise a plurality of curtain protection portions. As appreciated, the curtain protection 130 may extend vertically between a chassis of the road vehicle 10 and the ground. The skilled person appreciates that there are many variants possible for the curtain protection 130 to fulfill its purpose.

The curtain protection 130 may be extendible from the underside of the road vehicle 10 to the charge rail 100, or from the charge rail 100 to the underside of the road vehicle 10.

The curtain protection 130 may comprise one or more breakers configured to stop a charging of the parked road vehicle 10 upon the curtain protection 130 being tampered with. The one or more breakers may be arranged to break a charging control connection. Normally, breaking of the charging control connection breaks charging of the battery 4 of the road vehicle. Conceptually, this may be achieved by having a secondary electrical circuit being closed while the road vehicle 100 is charged, and the curtain protection 130 is extended to protect the charge rail 100 from its exterior environment. Once the curtain protection 130 is tampered with, the secondary electrical circuit may be broken. In response to this breaking of the secondary electrical circuit, charging of the parked road vehicle 10 may be stopped, thereby facilitating safety in terms of, e.g., high-current protection, fire prevention, or the like.

Additionally, or alternatively, the safety arrangement may comprise one or more of a radar, a camera, a temperature sensor, and a passive infrared, PIR, sensor. Each of these alternatives may detect presence of an object or a living being in vicinity of the charge rail 100 while charging the parked road vehicle 10. In the event of the safety arrangement be a PIR sensor, this may be configured to detect presence of a living being small in terms of weight and/or size compared to a human, e.g., a cat, a bird, or the like. In the event of the safety arrangement be a temperature sensor or a PIR sensor, breaking of charging current may be done upon detecting an abnormal temperature in connection with charging the parked road vehicle 10. That is, the safety arrangement may detect an abnormal, possibly hazardously high temperature of the charge rail 100 and its electrical connection to the parked road vehicle 10 originating from electrical short circuit or other possible connection issues. As a further safety measure, built-in safety means in the electrical circuits associated with the charge rail 100 may be present, such as a voltage meter and a switch thereof to prevent a possible temporary overload in the electricity network, or an ampere meter and a switch thereof to prevent possible DC overload upon charging the parked road vehicle 10.

In connection with FIGS. 3-6 there is shown a system for charging a parked road vehicle 10. The system comprises the charge rail 100. The above description regarding the charge rail 100 applies also for the system. To avoid undue repetition, features and advantages regarding the charge rail 100 therefore refer to the above when applicable.

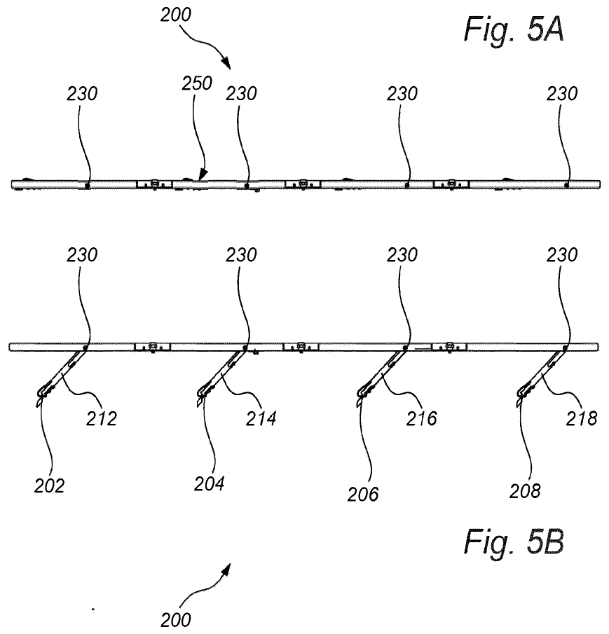

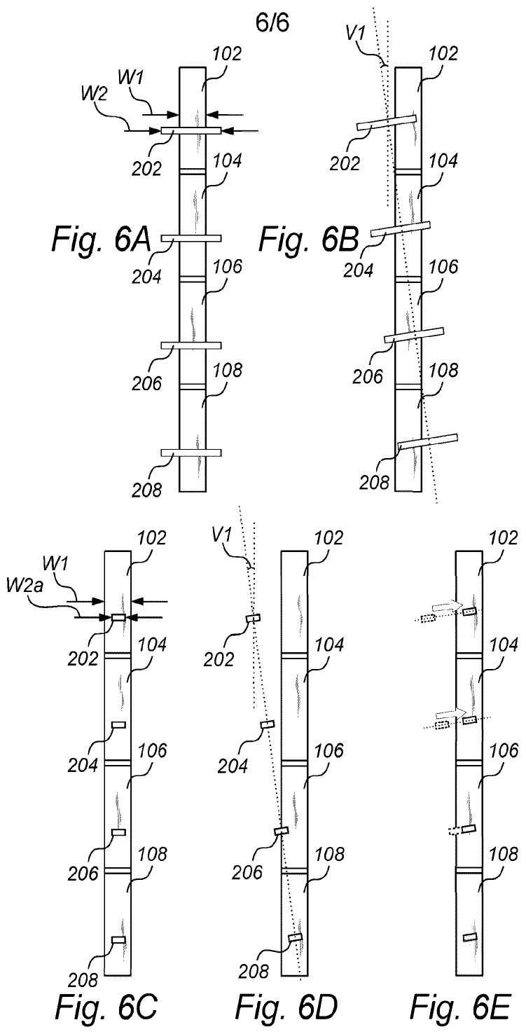

The system further comprises a charge pickup arrangement 200 connected to a chassis of a road vehicle 10 (FIGS. 5-6). The charge pickup arrangement 200 has a set of connecting elements 202, 204, 206, 208. The set of connecting elements comprises a charging control connecting element 202, a first charging connecting element 204, a second charging connecting element 206, and a protective Earth, PE, connecting element 208. In case of a CCS compatible charge rail 100 comprising the Combined Charging System, CCS, arrangement 120, the charging control connecting element 202 may be referred to as a control pilot, CP, connecting element, the first charging connecting element 204 may be referred to as a negative direct current, DC−, connecting element, and the second charging connecting element 206 may be referred to as a positive direct current, DC+, connecting element.

The system may further comprise a safety arrangement configured to stop a charging of the parked road vehicle upon a foreign object approaching the charge rail. As per the above, the safety arrangement may include a curtain protection 130. The curtain protection 130 may be attached to the charge pickup arrangement 200 and thereby being extendible from the charge pickup arrangement 120 to the surface on which the charge rail 100 is located. Other features of the curtain protection 130 may be as described above.

Further, the safety arrangement may comprise one or more of a radar, a camera, a temperature sensor, and a passive infrared, PIR, sensor. Again, the above description of these features may apply also here.

A proximal end of each connecting element 202, 204, 206, 208 of the set of connecting elements may be vertically movable to form an electrical contact to a matching segment 102, 104, 106, 108 of the charge rail 100, thereby allowing charging of the road vehicle 10. Each connecting element 202, 204, 206, 208 may be suspended by an arm 212, 214, 216, 218 allowing the vertical movement of the connecting elements. Preferably, each connecting element 202, 204, 206, 208 is suspended by a pair of arms 212, 214, 216, 218 such that the connecting element is connected to respective end of the two arms. Hence, each connecting element may be elongated. A distance between the ends of the pair of arms, i.e., substantially a length W2 of the connecting element, may be in the range 100-700 mm, more preferably 250-600 mm, and even more preferably 400-500 mm. However, the length W2 of the connecting element may differ from these values without departing from the claimed scope. While charging the road vehicle 10, each connecting element 202, 204, 206, 208 may, along its elongated extension, extend substantially perpendicularly to the longitudinal extension LE of the charge rail 10, provided the road vehicle 10 is correctly parked over the charge rail 100. The length W2 of each connecting element may thereby introduce a tolerance for parking such that charging may be possible even if the road vehicle 10 is obliquely parked over the charge rail. This situation is schematically exemplified in FIGS. 6A-6B. In FIG. 6A the set of connecting elements are centrally arranged above the charge rail 100 such that each connecting element 202, 204, 206, 208 forms contact with its matching segment 102, 104, 106, 108 of the charge rail 100. In FIG. 6B, there is schematically shown an obliquely arranged charge pickup arrangement, i.e., an obliquely parked road vehicle, over the charge rail 100. In practice, this may correspond to a longitudinal extension of the road vehicle 10 forming an angle V1 relative the longitudinal extension of the charge rail 100. Since the length W2 of a connecting element may be larger than the width of a segment W1, a sufficient electrical contact between the charge pickup arrangement 200 and the charge rail 100 may be possible for angles V1 being below a threshold angle. This threshold angle thereby depends on the length W2 of the connecting elements 202, 204, 206, 208 and the width W1 of the segments 102, 104, 106, 108.

Alternatively, each connecting element 202, 204, 206, 208 may be laterally movable (FIG. 6E), thereby be allowed to have a shorter length W2a without unnecessarily restricting parking tolerance. For instance, the length W2a of each conducting element 202, 204, 206, 208 may in such a situation be 30-100 mm. That is, each connecting element 202, 204, 206, 208 may be movable relative to the charge pickup arrangement 200 to make electrical contact with a matching segment 102, 104, 106, 108 of the charge rail 100. A lateral movement distance may for instance be 200-600 mm. Hence, a lateral position of each connecting element 202, 204, 206, 208 may be adjusted subsequently for an obliquely parked road vehicle. By way of example, as depicted in FIG. 6D, the road vehicle 10 may be parked such that the PE connecting element 208 and the PE segment 108 are initially in contact, while the charging control connecting element 202 and the charging control segment 102 are substantially misaligned by, e.g., 300 mm. The charging control connecting element 202 may hence be laterally moved approximately 300 mm to form electrical contact with the charging control segment 102. The remaining connecting elements may be aligned, if necessary, with their matching segments accordingly. In connection with FIG. 6D it is appreciated that the misalignment, for the angle V1, could have been reduced if the first and second charging connecting elements 204, 206 had initially been in contact with their respective segments 104, 106.

Each connecting element 202, 204, 206, 208 of the set of connecting elements may be pivotably attached to the chassis of the road vehicle 10. Preferably, the connecting elements 202, 204, 206, 208 may be pivotably attached indirectly to the chassis of the road vehicle 10 via a frame 250 of the charge pickup system 200. Hence, each connecting element 202, 204, 206, 208 may comprise a hinge 230 connecting the connecting element with the frame 250 of the charge pickup system 200. Such a hinge 230 may be of any adequate type. An arm 212, 214, 216, 218 connecting the connecting element 202, 204, 206, 208 with the frame 250 of the charge pickup system 200 may thereby be articulated relatively the frame 250. The arm 212, 214, 216, 218, and thereby the connecting element 202, 204, 206, 208 may be mechanically, hydraulically, or pneumatically controlled for vertical movement of the connecting element 202, 204, 206, 208. As appreciated, the term “vertically” as used above applies when the charge pickup system 200 is attached to the chassis of the road vehicle 10 such that a lateral plane of the charge pickup system 200 is substantially parallel to a surface on which the road vehicle 10 is located.

Each connecting element 202, 204, 206, 208 of the set of connecting elements may comprise a biasing member configured to provide an additional pressure between each connecting element 202, 204, 206, 208 and a matching segment 102, 104, 106, 108 while charging the road vehicle 10. The biasing member may be a mechanical spring. Alternatively, the additional pressure may be achieved by hydraulic or pneumatic means.

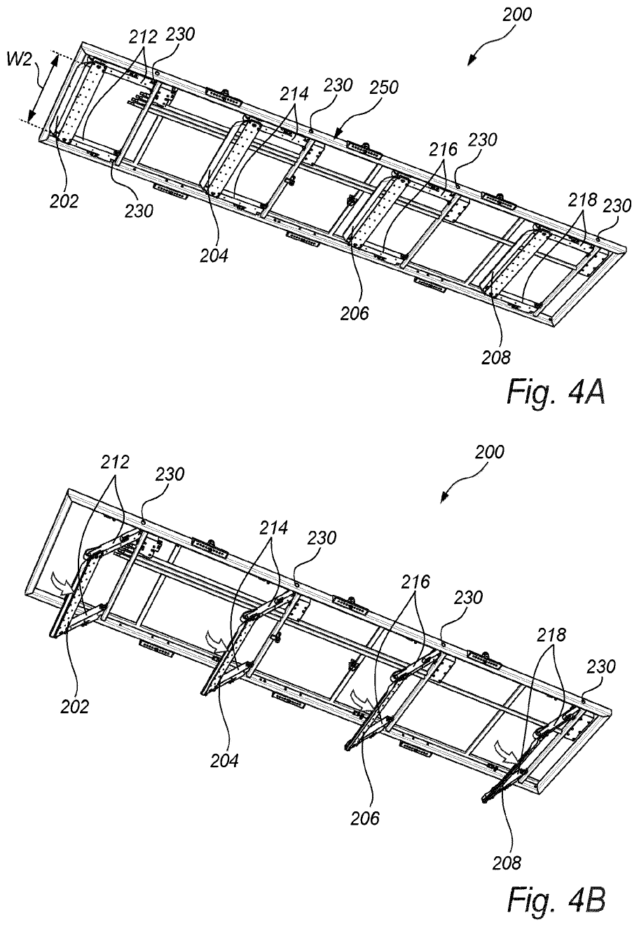

FIGS. 4A and 4B show the connecting elements 202, 204, 206, 208 being folded up, i.e., in a position normal while driving the road vehicle 10. FIGS. 5A-5B show a sideview of the charge pickup arrangement 200, wherein FIG. 5A corresponds to FIG. 4A, and FIG. 5B corresponds to FIG. 4B. A mounting direction of the charge pickup arrangement 200 may be as depicted in FIG. 3. That is, in the event the connecting elements 202, 204, 206, 208 are pivotably suspended, a corresponding hinge 230 may be located horizontally behind the respective proximal end while driving the road vehicle 10 forward. However, the opposite may be equally applicable, i.e., a corresponding hinge 230 may be located horizontally in front of the respective proximal end while driving the road vehicle 10 forward. The latter mounting direction thereby corresponds to the charge pickup arrangement 200 being laterally flipped 180 degrees.

Accordingly, and in summary a charge rail 100 and a system for charging a parked road vehicle 10 have been disclosed, facilitating a convenient approach for charging the road vehicle 10. For instance, the charge rail 100 may be arranged on a cargo platform such that charging may, via a charge pickup arrangement 200, be done during loading and/or unloading of a truck 10, thereby saving time since charging and loading/unloading can be done simultaneously. The approach may equivalently be exploited for private purposes, such as charging an ordinary at least partially electrical car.

The person skilled in the art realizes that the present invention by no means is limited to the preferred embodiments described above. On the contrary, many modifications and variations are possible within the scope of the appended claims.

1-16. (canceled)

17. A charge rail for charging a parked road vehicle, the charge rail being arranged to be located on ground, the charge rail comprising:
a charging control segment;
a first charging segment;
a second charging segment; and
a Protective Earth, PE, segment;
wherein the segments are arranged one after another along a longitudinal extension of the charge rail, are electrically conducting, and are mutually electrically isolated from each other,
wherein each segment is configured to be contacted by a matching connecting element of a charge pickup arrangement connected to a chassis of the road vehicle to form a respective electrical contact, thereby allowing charging of the road vehicle.

18. The charge rail according to claim 17, further comprising a base supporting the segments.

19. The charge rail according to claim 18, further comprising a combined charging system, CCS, arrangement comprising:
a control pilot, CP, connector;
a negative direct current, DC−, connector;
a positive direct current, DC+, connector; and
a protective Earth, PE, connector,
wherein the CP connector is connected to the charging control segment, the DC− connector is connected to the first charging segment, the DC+ connector is connected to second charging segment, and the PE connector is connected to the PE segment, and
wherein the base supports the CCS arrangement.

20. The charge rail according to claim 17, wherein the segments have a same longitudinal extension, preferably in a range of 500-900 mm.

21. The charge rail according to claim 17, wherein the first and second charging segments are arranged between the charging control segment and the PE segment.

22. The charge rail according to claim 17, further comprising a switch configured to switch a polarity of the first and second charging segments.

23. The charge rail according to claim 17, wherein an underside of the base comprises an insulating layer.

24. A stationary charger arrangement comprising:
a charge rail according to claim 17; and
a safety arrangement configured to stop a charging of the parked road vehicle upon a foreign object approaching the charge rail.

25. The stationary charger arrangement according to claim 24, wherein the safety arrangement comprises a curtain protection arranged along the charge rail, wherein the curtain protection is extendible between the parked road vehicle and a surface on which the charge rail is arranged.

26. The stationary charger arrangement according to claim 24, wherein the curtain protection comprises one or more breakers configured to stop a charging of the parked road vehicle upon the curtain protection being tampered with.

27. The stationary charger arrangement according to claim 24, wherein the safety arrangement is configured to detect presence of an object or a living being in vicinity of the charge rail while charging the parked road vehicle and comprises one or more of a radar, a camera, a temperature sensor, and a passive infrared, PIR, sensor.

28. A system for charging a parked road vehicle, the system comprising:
a charge rail according to claim 17; and
a charge pickup arrangement connected to a chassis of the road vehicle, the charge pickup arrangement having a set of connecting elements comprising:
a charging control connecting element;
a first charging connecting element;
a second charging connecting element; and
a protective Earth, PE, connecting element,
wherein a proximal end of each connecting element of the set of connecting elements is vertically movable to form an electrical contact to a matching segment of the charge rail, thereby allowing charging of the road vehicle.

29. The system according to claim 28, further comprising a safety arrangement configured to stop a charging of the parked road vehicle upon a foreign object approaching the charge rail.

30. The system according to claim 28, wherein each connecting element (of the set of connecting elements is pivotably attached to the chassis of the road vehicle.

31. The system according to claim 28, wherein each connecting element of the set of connecting elements comprises a biasing member configured to provide an additional pressure between each connecting element and a matching segment while charging the road vehicle.
